(19) United States
(12) Patent Application Publication
(10) Pub. No.: US 2025/0254141 A1
(43) Pub. Date: Aug. 7, 2025

(54) AI-ASSISTED NOTIFICATIONS OF RELEVANT CONTENT DURING A VIRTUAL CONFERENCE

(71) Applicant: Zoom Video Communications, Inc., San Jose, CA (US)

(72) Inventors: Fanlei Hu, Hangzhou (CN); Chunhan Li, Hangzhou (CN); Gang Ren, Hangzhou (CN); Pan Zhang, Hangzhou (CN); Yamin Zhou, Hangzhou (CN)

(73) Assignee: Zoom Video Communications, Inc., San Jose, CA (US)

(21) Appl. No.: 18/433,975

(22) Filed: Feb. 6, 2024

(51) Int. Cl. H04L 51/224; H04L 12/18; H04L 51/046; H04L 51/063

(52) U.S. Cl. CPC H04L 51/224; H04L 12/1831; H04L 51/046; H04L 51/063

(57) ABSTRACT

An example method for AI-assisted notifications of relevant content during a virtual conference includes joining, by a client device, a virtual conference attended by one or more participants using a client application. For example, the client device may receive, a transcript of the virtual conference from a server during the virtual conference and determine if the transcript includes a phrase associated with the participant. In response to determining that the transcript includes the phrase associated with the participant, outputting a notification to the participant on a graphical user interface (GUI) provided by the client application.

### FIELD

The present disclosure relates generally to virtual conferencing, and more particularly to AI-assisted notifications of relevant content during a virtual conference.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-2 show example systems for providing AI-assisted notifications during virtual conferences;

FIG. 3 shows an example system for providing AI-assisted notifications during virtual conferences;

FIGS. 4A-4B shows an example graphical user interface suitable for use with example systems and methods for providing AI-assisted notifications during virtual conferences;

FIGS. 5-7 show examples of information provided with notifications suitable for use with example systems and methods for providing AI-assisted notifications during virtual conferences;

FIGS. 8-11 show examples of types of notifications suitable for use with example systems and methods for providing AI-assisted notifications during virtual conferences;

FIG. 12 shows an example of types of settings for notifications a participant may select suitable for use with example systems and methods for providing AI-assisted notifications during virtual conferences;

FIG. 13 shows an example of a meeting summary report suitable for use with example systems and methods for providing AI-assisted notifications during virtual conferences;

FIG. 14 shows an example method for providing AI-assisted notifications during virtual conferences; and

FIG. 15 shows an example computing device suitable for use with example systems and methods for providing AI-assisted notifications during virtual conferences.

### DETAILED DESCRIPTION

Examples are described herein in the context of highlighting text during a virtual conference. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

During a virtual conference, participants may engage in discussions about a variety of topics over an extended period of time. In some instances, a participant may be distracted or otherwise shift their attention from the discussion to other matters unrelated to the virtual conference. During these instances of distraction, the participant may find it useful to be notified by an AI-assistant to re-engage the participant with the virtual conference.

The AI-assistant may monitor a transcript of the virtual conference to identify important content within the transcript. The transcript may textually represent interactions (e.g., audio discussions, text chat, or similar) during the virtual conference. In response to identifying important content within the transcript, the AI-assistant may generate a type of notification (e.g., pop-up alert, chime, or similar) for the participant. The type of notification may be selected by the AI-assistant or the participant based on desired preferences or global meeting settings. The general purpose of the notification is to let the participant know that an event has occurred that may be of interest.

In some instances, a portion of the transcript may be included with the notification sent to the participant. The portion of the transcript may include brief summaries or contextual snippets helping the participant understand the notification. In other instances, the portion of the transcript may be contextually shortened or reorganized by the AI-assistant to provide a “to the point” summary to the participant to enable the participant to quickly grasp what is currently occurring in the virtual conference. The AI-assistant may also provide an entirety of the transcript to the participant during or after the meeting.

This illustrative example is given to introduce the reader to the general subject matter discussed herein and the disclosure is not limited to this example. The following sections describe various additional non-limiting examples and examples of AI-assisted notifications of relevant content during a virtual conference.

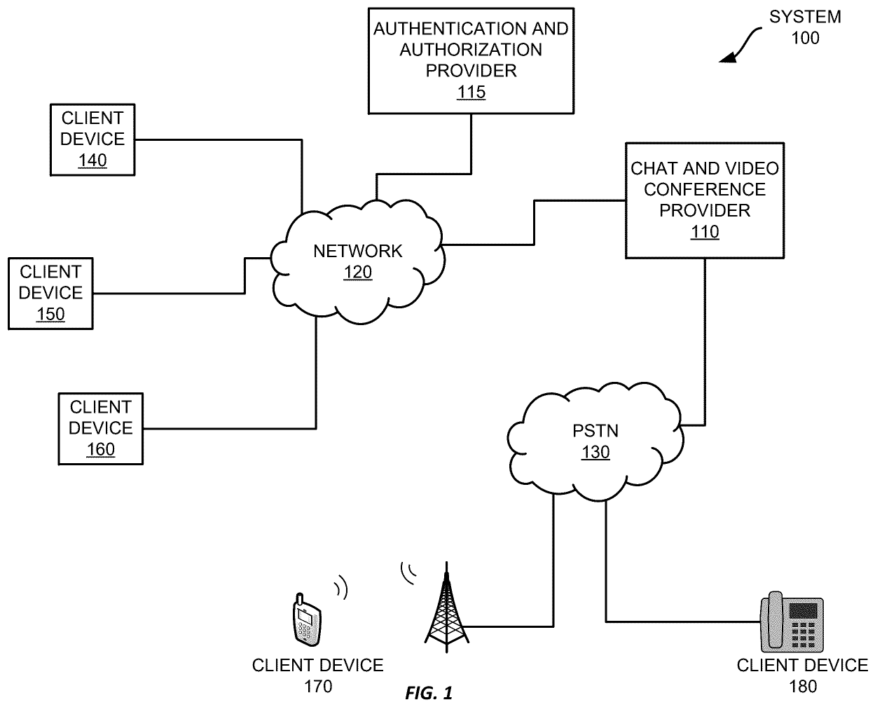

Referring now to FIG. 1, FIG. 1 shows an example system 100 that provides videoconferencing functionality to various client devices. The system 100 includes a chat and video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a chat and video conference provider 110 may supply components to enable a private organization to host private internal video conferences or to connect its system to the chat and video conference provider 110 over a public network.

The system optionally also includes one or more authentication and authorization providers, e.g., authentication and authorization provider 115, which can provide authentication and authorization services to users of the client devices 140-160. Authentication and authorization provider 115 may authenticate users to the chat and video conference provider 110 and manage user authorization for the various services provided by chat and video conference provider 110. In this example, the authentication and authorization provider 115 is operated by a different entity than the chat and video conference provider 110, though in some examples, they may be the same entity.

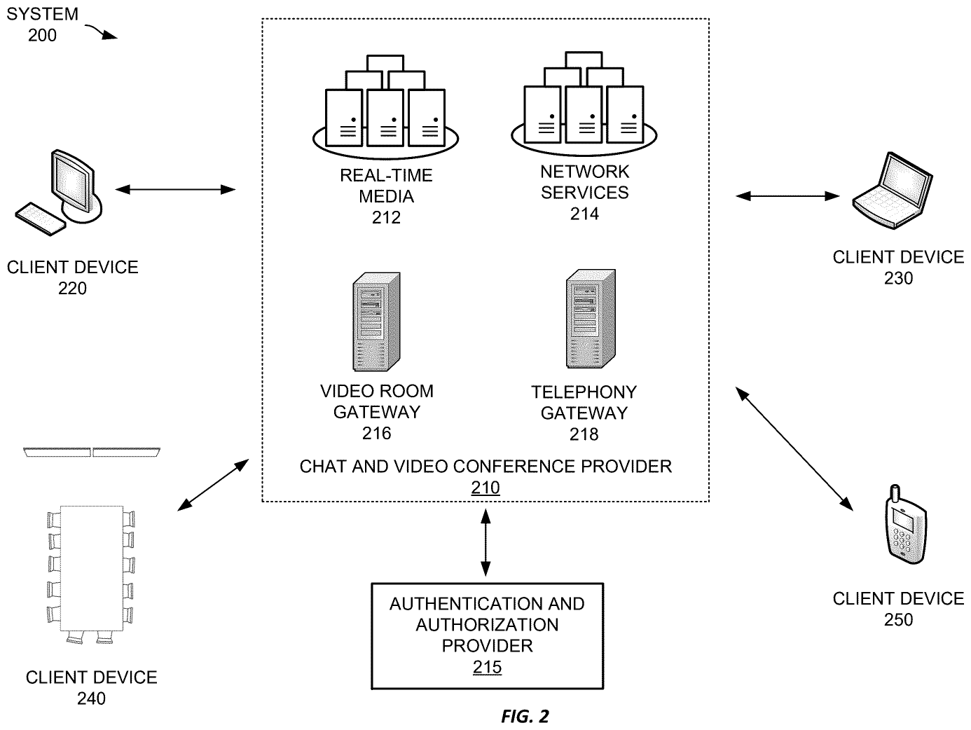

Chat and video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example chat and video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or a client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started, or the host may be required to specifically admit one or more of the users.

During the meeting, the participants may employ their client devices 140-180 to capture audio or video information and stream that information to the chat and video conference provider 110. They also receive audio or video information from the chat and video conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communication devices that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and are not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user authentication information, meeting identifiers, meeting passwords or passcodes, etc. In examples that employ an authentication and authorization provider 115, a client device, e.g., client devices 140-160, may operate in conjunction with an authentication and authorization provider 115 to provide authentication and authorization information or other user information to the chat and video conference provider 110.

An authentication and authorization provider 115 may be any entity trusted by the chat and video conference provider 110 that can help authenticate a user to the chat and video conference provider 110 and authorize the user to access the services provided by the chat and video conference provider 110. For example, a trusted entity may be a server operated by a business or other organization with whom the user has created an account, including authentication and authorization information, such as an employer or trusted third-party. The user may sign into the authentication and authorization provider 115, such as by providing a username and password, to access their account information at the authentication and authorization provider 115. The account information includes information established and maintained at the authentication and authorization provider 115 that can be used to authenticate and facilitate authorization for a particular user, irrespective of the client device they may be using. An example of account information may be an email account established at the authentication and authorization provider 115 by the user and secured by a password or additional security features, such as single sign-on, hardware tokens, two-factor authentication, etc. However, such account information may be distinct from functionality such as email. For example, a health care provider may establish accounts for its patients. And while the related account information may have associated email accounts, the account information is distinct from those email accounts.

Thus, a user's account information relates to a secure, verified set of information that can be used to authenticate and provide authorization services for a particular user and should be accessible only by that user. By properly authenticating, the associated user may then verify themselves to other computing devices or services, such as the chat and video conference provider 110. The authentication and authorization provider 115 may require the explicit consent of the user before allowing the chat and video conference provider 110 to access the user's account information for authentication and authorization purposes.

Once the user is authenticated, the authentication and authorization provider 115 may provide the chat and video conference provider 110 with information about services the user is authorized to access. For instance, the authentication and authorization provider 115 may store information about user roles associated with the user. The user roles may include collections of services provided by the chat and video conference provider 110 that users assigned to those user roles are authorized to use. Alternatively, more or less granular approaches to user authorization may be used.

When the user accesses the chat and video conference provider 110 using a client device, the chat and video conference provider 110 communicates with the authentication and authorization provider 115 using information provided by the user to verify the user's account information. For example, the user may provide a username or cryptographic signature associated with an authentication and authorization provider 115. The authentication and authorization provider 115 then either confirms the information presented by the user or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide authentication information to authenticate the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide account information to the chat and video conference provider 110, even in cases where the user could authenticate and employs a client device capable of authenticating the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to chat and video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a chat and video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices, etc.

Referring now to FIG. 2, FIG. 2 shows an example system 200 in which a chat and video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more authentication and authorization providers 215, which can authenticate various users to the chat and video conference provider 210 generally as described above with respect to FIG. 1.

In this example, the chat and video conference provider 210 employs multiple different servers (or groups of servers) to provide different examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting an authentication and authorization provider 215 to verify the provided credentials. Once the user's credentials have been accepted, and the user has consented, the network services servers 214 may perform administrative functionality, like updating user account information, if the user has account information stored with the chat and video conference provider 210, or scheduling a new meeting, by interacting with the network services servers 214. Authentication and authorization provider 215 may be used to determine which administrative functionality a given user may access according to assigned roles, permissions, groups, etc.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may select a user to remove and issue a command through a user interface on their client device. The command may be sent to a network services server 214, which may then disconnect the selected user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have been completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosted by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio streams to the telephony gateway server 218. The telephony gateway server 218 determines the numbers or letters entered by the user and provides the meeting ID and passcode information to the network services servers 214, along with a request to join or start the meeting, generally as described above.

Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

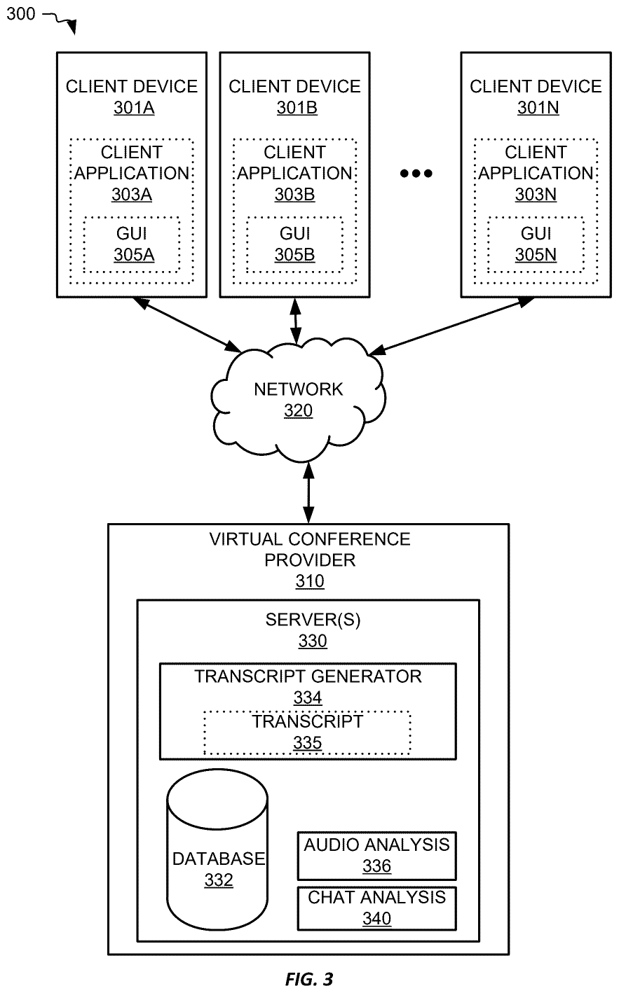

Referring now to FIG. 3, FIG. 3 shows an example system 300 using an artificial intelligence assistant “AI-assistant” to generate notifications during virtual conferences (or “meeting”). In this example, the system 300 may include client devices 301a, 301b, . . . , 301n, where n is a total number of client devices connected to a virtual conference provider 310 that hosts a virtual conference. The client devices 301 may include personal computers, smartphones, or any device that can connect participants to the virtual conference provider 310. Each of the client devices 301 executes client applications 303a-303n which may generate graphical user interfaces (GUI) 305a-305n, respectively. The client applications 303 connect to the virtual conference provider 310 over a network 320 via client devices 301.

The client device 301 executes client application 303 as discussed above, which in turn displays the GUI 305 on the client device 301 display (e.g., computer monitor, smartphone, or similar). In this example, the GUI 305 includes a virtual conference window that presents a current speaker to other participants. The current speaker may discuss topics, mention participants, or have dialog with other participants. The current speaker may dynamically shift depending on which participant is currently talking. In some examples, the GUI 305 may display notifications to the participants interacting in the virtual conference when certain topics or participants are mentioned during the video conference. In other examples, the GUI 305 may provide participants with adjustable parameters or settings (e.g., username, alias, or key topics/phrases the participant is interested in).

During the virtual conference, the participants can exchange audio and video streams, as discussed above with respect to FIGS. 1-2, to interact with each other, discuss any topics of interest, and share content. The audio and video streams may be received by one or more servers 330 from the network 320 for subsequent processing, generally as discussed above with respect to FIGS. 1-2. The server(s) 330 may perform audio analysis 336 on the received audio stream or chat analysis 340 on text chat (e.g., global chat, direct messages) entered in the virtual conference. The audio streams are also provided to a transcript generator 334 (e.g., an automatic speech recognition “ASR”, speech-to-text, or similar transcription process).

A transcript 335 is then generated by the transcript generator 334. In some examples, the transcript 335 may include transcribed text from some or all participants of the virtual conference. The transcript 335 may be generated substantially in real-time or may be generated after certain events (e.g., when participants finish speaking). In some examples, the transcript 335 may also include chat text (e.g., direct messages, global chat, or similar) from a virtual conference chat window where participants type their discussions rather than speak.

When the transcript generator 334 generates the transcript 335, the virtual conference provider 310 provides the transcript 335 to the client devices 301 via the network 320. In some examples, the transcript 335 may be provided to only one client device 301, some client devices 301, or every client device 301. In another example, the transcript 335 is sent in real-time as it is generated; however, the transcript 335 may be sent to client devices 301 based on preferences received by the virtual conference provider 310. In other examples, the transcript 335 may be requested by the client device 301.

After receiving the transcript 335 substantially in real-time, the client device 301 searches the transcript 335 for a word or phrase spoken or typed by the current speaker attending the meeting. For example, the AI-assistant may search for a word or phrase. Words or phrases may be identified by literal string matches, e.g., by finding exact matches to key words or phrases, or they may be identified based on semantic content or using other techniques described herein. The word or phrase may be, but not limited to, a word, a group of words, a name, an alias, a username, a reference, symbol, number, or similar. In some examples, the word or phrase spoken or typed may include a subset of words within the transcript 335. The subset of words does not have to be grammatically correct and can include more than one sentence and in no particular order. The subset of words may provide context or easily understandable content to the participant. In other examples, the transcript 335 may be provided to a suitable text analysis software program or large language model software program (e.g., ChatGPT or similar) to determine if transcript 335 contains text that is relevant to the participant.

In some examples, if the AI-assistant determines (e.g., using ChatGPT or similar) that the subset of words of the transcript 335 provide context to the word or phrase, the AI-assistant will cause the client device 301 to output the subset of words on the GUI 305 to the participant. In addition, or alternatively, the AI-assistant may search the transcript 335 for concepts (e.g., project X has deadline Y) or topics (e.g., performance reviews). In other examples, the AI-assistant may determine (e.g., using ChatGPT or similar) that the selected subset of words provide context to the word or phrase and provide modifications to the subset of words. The modifications by the AI-assistant may include highlighting, bolding, italicizing, underlining, changed font size, changed font, or combinations thereof. Subsequently, the AI-assistant may cause the client device 301 to output the subset of words of the transcript 335 that include the modifications in the GUI 305 to the participant.

In other examples, machine learning may be implemented to generate an embedding when the transcript 335 is received. The user may have also provided information about topics or other information of interest, e.g., names of other participants or colleagues, from which concept embeddings have been generated. Machine learning may then be used to search for similarities between the embeddings generated from the transcript and the relevant concept embeddings to determine if the participant should receive a notification (e.g., “A topic you are interested in was mentioned!”) via the GUI 305. Alternatively, or in addition, a portion or chunk of the transcript 335 may be provided to a suitable text analysis software program or large language model software program (e.g., ChatGPT or similar) to determine if transcript 335 contains text that is relevant to the participant. Similarly, the AI-assistant may determine that the selected subset of words provide context to the word or phrase (e.g., using ChatGPT or similar) and subsequently modify the portion or chuck of the transcript 335 to provide text which is more easily readable and understandable.

In some examples, The AI-assistant executed by the client device 301 may determine if the word or phrase within the transcript 335 is associated with the participant by comparing the word or phrase to a parameter or a preference (e.g., predefined keyword or topic prescribed by the participant or AI-assistant). The parameter may be retrieved by the client device 301. In some examples, the parameter may be input, changed, or updated by the participant before, during, or after the virtual conference. In other examples, the parameter may be an input setting defined by the participant that is subsequently sent to the server(s) 330. It should be appreciated, however, that the parameter may be retrieved from any source capable of being associated with the participant. The parameter may include a name, an alias, demographic information about the participant, historical data about the participant, contextual topics associated with the participant, a preference of the participant, or a combination thereof.

When the AI-assistant determines if the word or phrase within the transcript 335 is associated the parameter, a notification to the participant may be displayed by the GUI 305 to the participant. The notification may be displayed to the participant when the determination by the AI-assistant is made or displaying the notification to the participant may be delayed (e.g., a few seconds). The participant may use GUI 305 to adjust a type of the notification (e.g., provide visual notifications only, use pop-up notifications) or specific settings of the notification (e.g., parameters, frequency of notifications, information to include in the notification, or similar). In other examples, the notifications may be provided to some or all participants of the virtual conference.

The client application 303 may also monitor a state of the participant (e.g., detecting speaking, recent movement from a camera, text chat, or similar). For example, if the participant has received the notification including a message, such as the word or phrase, but not performed an interaction (e.g., speaking, clicking, typing) with the client application 303 within a time threshold (e.g., a few seconds or minutes) then the AI-assistant may output a second notification including a second message. The second message may include highlighted text (e.g., color highlighted, bold, italicized) and an audio response, a visual response, a tactile response, a haptic response, or a combination thereof.

In some aspects, the client device 301 may determine if the state (active state or inactive state) of the participant meets an engagement threshold. The engagement threshold may include comparisons of the participants audio or video streams by the AI-assistant to determine if the participant is engaging with the virtual conference. For example, if the participant has not spoken during the meeting for a predetermined time threshold (e.g., five minutes) then the AI-assistant may determine that the participant is in an inactive state. Alternatively, if the participant has recently spoken during the virtual conference then the AI-assistant may determine that the participant is in an active state. In some examples, the AI-assistant may send the notification to the participant based on whether the participant is in an active state or an inactive state.

In other examples, the AI-assistant may determine if the participant meets the engagement threshold by monitoring the participants video stream to determine if the participant is looking at the display or not (using the client device's camera or similar techniques). For example, the participant may look away from the client device 301 screen for a period of time (e.g., a few seconds or minutes) and the AI-assistant will determine that the participant is in the inactive state, such as based on the amount of time they have been looking away from the screen. In some examples, the AI-assistant may determine if the client application 303 is executing in the foreground or background of the client device 301. For example, the participant may minimize or otherwise adjust (e.g., click on another software application) the client application 303 in order to answer an email or respond to a message thus diverting the participants attention from the virtual conference.

In further examples, the AI-assistant may determine if the participant has adjusted the client devices 301 volume. In this example, the AI-assistant identifies if the participant has muted the virtual conference (intentionally or unintentionally) to make a determination if the participant has met the engagement threshold.

Different levels of notifications may be selected based on the state of the participant. For example, if the participant is determined to be in an inactive state, the AI-assistant may provide a pop-up notification as well as an alert if the participant is mentioned. The alert may include an audio response, a visual response, a tactile response, a haptic response, or a combination thereof. In other aspects, if the participant is determined to be in an active state, the AI-assistant may provide a minimally distracting notification (e.g., a small pop-up away from the current speaker) to not distract the participant from the virtual conference.

In some examples, the client device 301 may determine that the virtual conference has ended (e.g., meeting concluded and participants are exiting the meeting). The client device 301 may retrieve the transcript 335 for an entirety of the virtual conference. Subsequently the client device 301 may generate a report based on the transcript 335 which will include at least the word or phrase. The report can include some or all of the transcript 335 or may be partitioned into contextual sections (e.g., section divided by topics or speakers) that include portions of the transcript 335. The AI-assistant may store the report on the client device 301 or transmit the report, using the client device 301, to the server(s) 330 for subsequent dissemination to other participants. Alternatively, the report may be generated by the server(s) 330 and transmitted to each client device 301.

In certain examples, a database 332 may be used to store or retrieve portions of the audio or video streams. The database 332 may also be used to store or retrieve the transcript 335 from a current virtual conference or a past virtual conference. It should be appreciated that while the database 332 in this example is hosted by the server(s) 330, examples may utilize databases 332 hosted by client devices 301 or other remote services, such as those maintained by third parties.

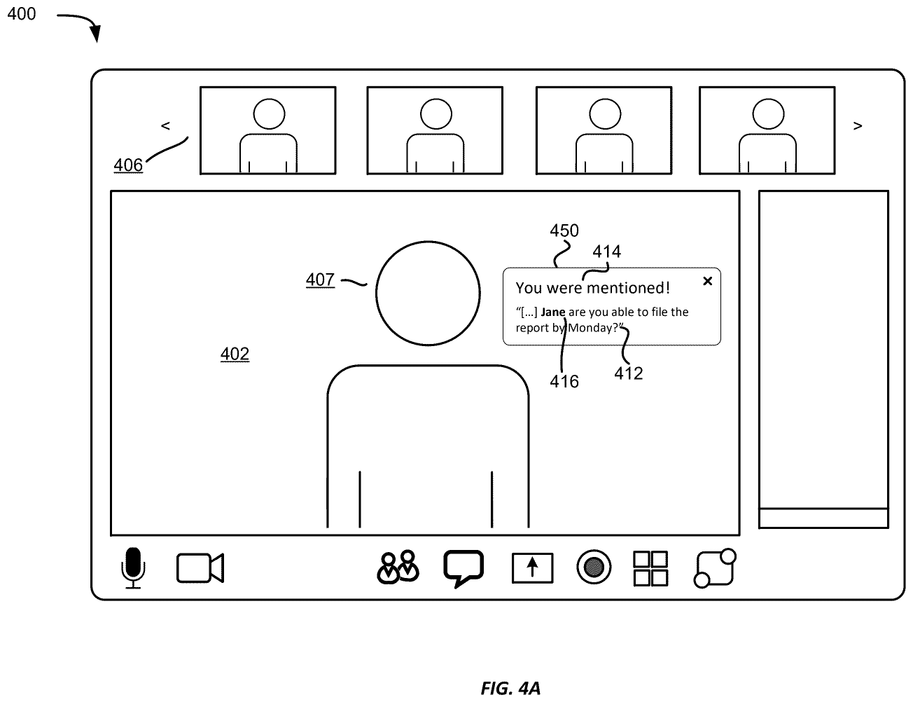

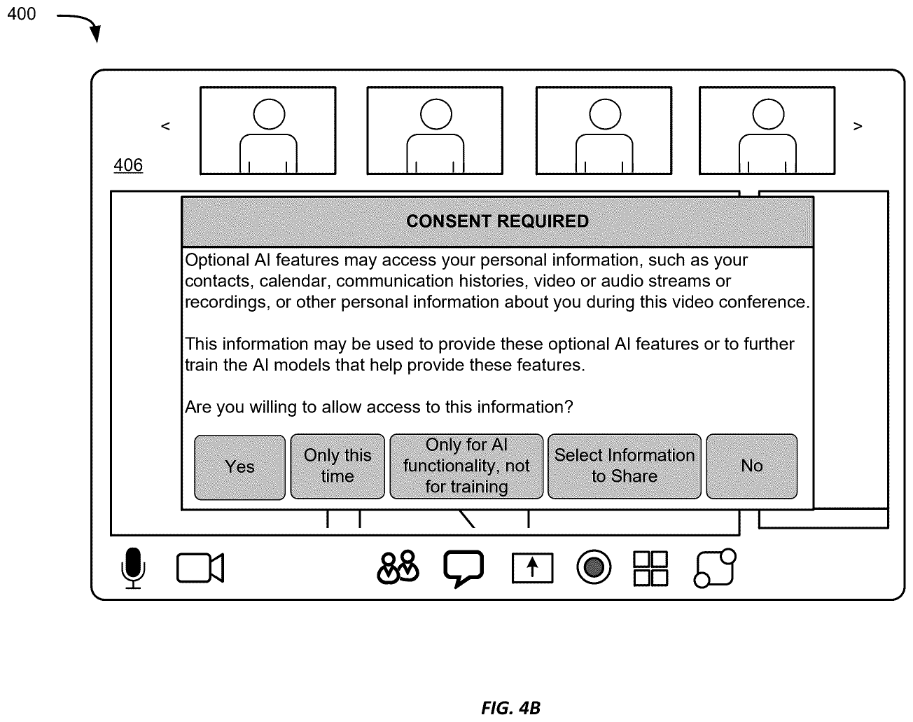

Referring now to FIGS. 4A-4B, while references will be made to specific components of the examples system shown in FIG. 3, it should be appreciated that the example shown in FIG. 4A is compatible with any example described herein. FIG. 4A shows an example GUI 400 suitable for use with systems and methods for providing AI-assisted notifications during a virtual conference. The GUI 400 of FIG. 4A may be executed by a client device 301. The client device 301 executes client application 303 as discussed above, which in turn displays the GUI 400 on the client device 301 display. In this example, the GUI 400 includes a virtual conference window 402 that presents a current speaker 407 to other participants 406. The current speaker 407 may discuss topics, mention participants 406, or have dialog with other participants 406. The current speaker 407 may dynamically shift depending on which participant 406 is currently talking.

During the virtual conference, the client device 301 will receive the transcript 335 from the virtual conference provider 310 substantially in real-time. The AI-assistant, executed by the client device 301, will search the transcript 335 for a word or phrase 412 using techniques described in examples in this disclosure. The AI-assistant may determine if the word or phrase 412 is associated with the participant by comparing the phrase 412 to a parameter 416 or a preference (e.g., predefined keyword or topic prescribed by the participant). The parameter 416 may be retrieved by the client device 301. In some examples, the parameter 416 may be input, changed, or updated by the participant before, during, or after the virtual conference. In other examples, the parameter 416 may be an input setting defined by the participant that is subsequently sent to the server(s) 330. It should be appreciated, however, that the parameter 416 may be retrieved from any source capable of being associated with the participant. The parameter 416 may include a name, an alias, demographic information about the participant, historical data about the participant, contextual topics associated with the participant, a preference of the participant, or a combination thereof.

Upon determining, by the client device 301, that the word or phrase 412 is associated with the parameter 416 using techniques described in examples herein, the client device 301 may provide a notification 450 to the participant (e.g., as a pop-up notification to get the participants attention during the meeting). The parameter 416 may be stored on the server(s) 330 for retrieval at a later time. Alternatively, the parameter 416 may be stored on the client device 301 or any suitable storage device in communication with the network 320.

The notification 450 may include the word or phrase 412, the parameter 416, a subject 414, or any number of context clues for the participant to determine why the notification 450 has been sent. The notification 450 does not be limited to occurring within the virtual conference window 402. For example, the notification 450 may be sent by way of email or short message service “SMS” text to a personal device other than the client device 301. The participant may receive the notification 450 from an operating system “OS” on the client device 301. In some examples, the notification 450 may require the participant to acknowledge receipt of the notification 450.

In other examples, the notification 450 may appear for a predetermined time period and may disappear after the predetermined time period has expired (e.g., ten seconds to a few minutes). In addition, the client device 301 may create a queue of notifications to display to the participant. In some examples, each notification 450 may appear for a predetermined time period (e.g., 5-10 seconds) before a new notification is displayed. The predetermined time periods may be determined by the participant or may be predetermined by the AI-assistant. In other examples, a different participant may determine what notifications the participant receives. The notification 450 does not need to be limited to the pop-up notification described above and may include any of an audio response, a visual response, a tactile response, a haptic response, or a combination thereof.

Referring now to FIG. 4B, FIG. 4B shows the GUI 400 presenting a consent option to employ certain AI-assisted features. In some examples according to the present disclosure, a user may select an option to use one or more optional AI features available from the virtual conference provider. The use of these optional AI features may involve providing the user's personal information to the AI models underlying the AI features. The personal information may include the user's contacts, calendar, communication histories, video or audio streams, recordings of the video or audio streams, transcripts of audio or video conferences, or any other personal information available the virtual conference provider. Further, the audio or video feeds may include the user's speech, which includes the user's speaking patterns, cadence, diction, timbre, and pitch; the user's appearance and likeness, which may include facial movements, eye movements, arm or hand movements, and body movements, all of which may be employed to provide the optional AI features or to train the underlying AI models.

Before capturing and using any such information, whether to provide optional AI features or to providing training data for the underlying AI models, the user may be provided with an option to consent, or deny consent, to access and use some or all of the user's personal information. In general, Zoom's goal is to invest in AI-driven innovation that enhances user experience and productivity while prioritizing trust, safety, and privacy. Without the user's explicit, informed consent, the user's personal information will not be used with any AI functionality or as training data for any AI model. Additionally, these optional AI features are turned off by default-account owners and administrators control whether to enable these AI features for their accounts, and if enabled, individual users may determine whether to provide consent to use their personal information.

As can be seen in FIG. 4B, a user has engaged in a video conference and has selected an option to use an available optional AI feature. In response, the GUI has displayed a consent authorization window for the user to interact with. The consent authorization window informs the user that their request may involve the optional AI feature accessing multiple different types of information, which may be personal to the user. The user can then decide whether to grant permission or not to the optional AI feature generally, or only in a limited capacity. For example, the user may select an option to only allow the AI functionality to use the personal information to provide the AI functionality, but not for training of the underlying AI models. In addition, the user is presented with the option to select which types of information may be shared and for what purpose, such as to provide the AI functionality or to allow use for training underlying AI models.

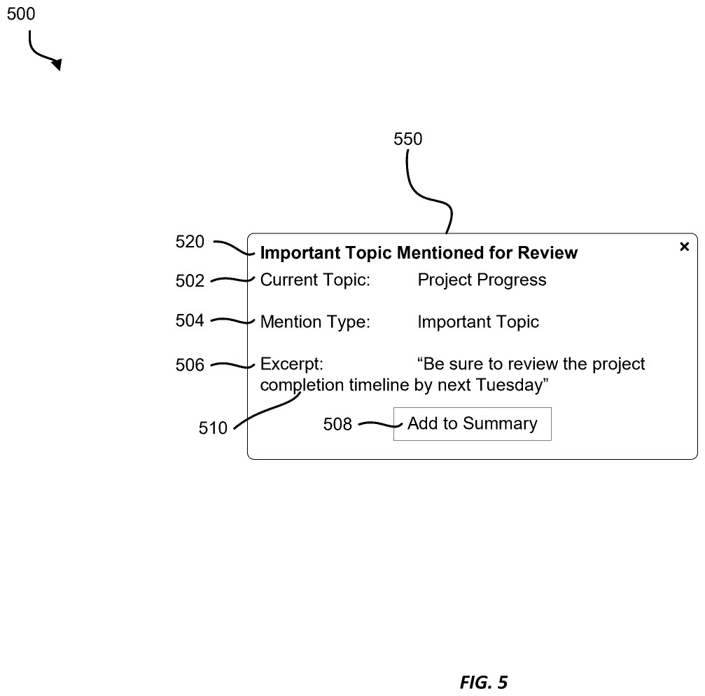

Referring now to FIG. 5, FIG. 5 shows an example of an expanded view of a pop-up 500 including a notification 550. The notification 550 will be discussed with respect to the example system and example GUI above with respect to FIGS. 3 and 4. The notification 550 may include a subject 520 to help a participant quickly understand the notification 550. The subject 520 may be a predefined subject or a subject created from the transcript 335 that contains contextual content (e.g., topics, participants, relevant text). Several types of sections may be included with the notification 550 including a current topic 502 that was discussed prior to sending the notification 550. Mention type 504 may include information on whether or not a participant was mentioned explicitly or if a topic the participant was interested in was mentioned. In addition, the notification 550 may include an excerpt 506 that includes context 510 of the notification 550. The context 510 can include a name or alias of the participant or may include a phase or topic that the participant is interested in. In some examples, the notification 550 may include an interactable function 508 that enables the participant to mark the notification 550 for reference after the meeting (e.g., a reminder about a topic or to highlight the moment in the meeting).

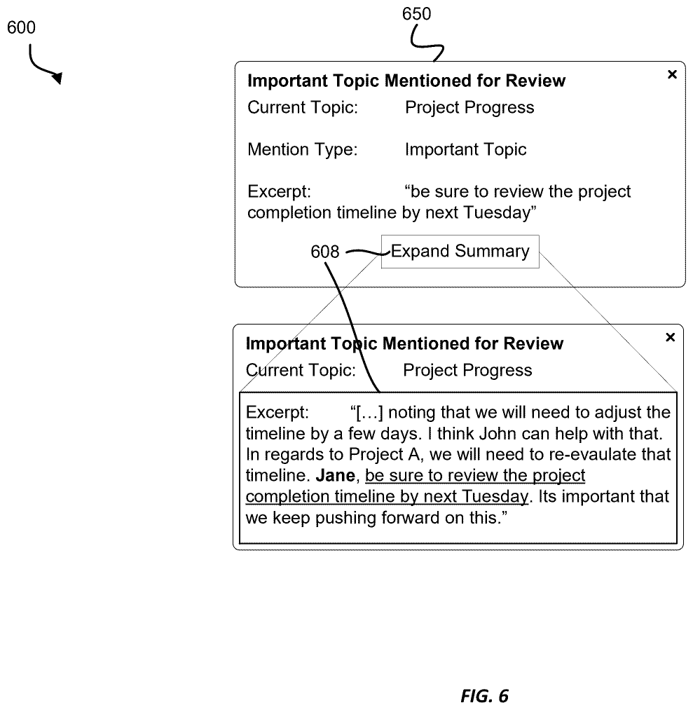

Referring to FIG. 6, FIG. 6 illustrates an expanded pop-up 600 configured to provide more context to a participant about a notification 650. The pop-up 600 described herein will be discussed with respect to the example system and example GUI above with respect to FIGS. 3 and 4. An expanded summary function 608 enables a participant to see more context of the notification 650. This enables the participant to see more information for instances where the participant wants more context for the excerpt or needs to review more information prior to taking an action. In a non-limiting example, specific portions of the expanded summary may be underlined or highlighted (e.g., color added, bolded, italicized, capitalized, or similar) to add emphasis.

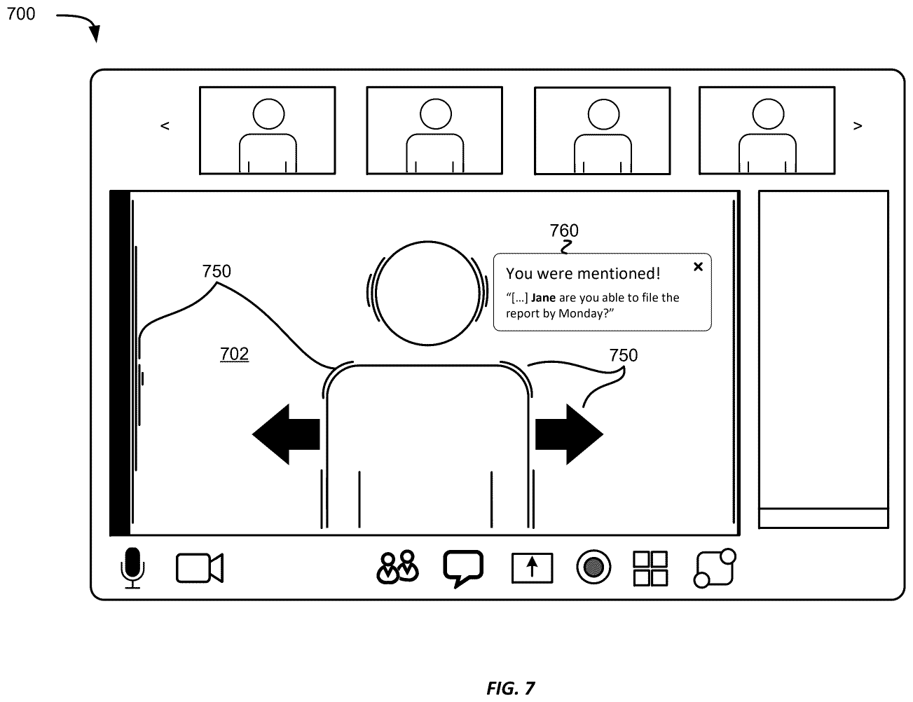

Referring to FIG. 7, FIG. 7 illustrates GUI 700 that includes a notification 750. The notification 750 described herein will be discussed with respect to the example system and example GUI above with respect to FIGS. 3 and 4. The notification 750 may include shaking a virtual conference window 702 back and forth, up or down, or diagonally to gain the participants attention. Alternatively, the notification 750 may shake some or all of GUI 700 or appear to shake the display of the client device 301. In examples where the device can output haptic effects, the notification 750 may also include outputting an actual haptic effect, e.g., a vibration, as well as the visual shaking of the GUI 700. In other aspects, the virtual conference window 702 may be visually altered in another way based on a participant's preference (e.g., zoom in and out, optical distortion, or similar).

For example, participants that are visually impaired or have a visual condition where shaking the screen could be unpleasant or cause harm (e.g., epileptic seizures induced by shaking colors back and forth giving off an apparent “blinking” effect) can choose to have a more dampened visual change such as a short burst to improve the participants enjoyment of the virtual conference. The participant could also change a frequency of the shaking or an intensity of the shaking. A pop-up notification 760, similar to the notifications in FIGS. 4-6, may be generated by the AI-assistant. The pop-up notification 760 may shake with the notification 750 or the pop-up notification 760 may remain stationary while the AI-assistant shakes portions of the display. In some examples, if the participant that receives the notification 750 is a current speaker, the participant may temporarily disable the notification 750 (e.g., a user defined preference, a button, or similar). In other examples, the AI-assistant may recognize that the participant is the current speaker and disable notifications until the participant is not speaking. It should be appreciated that this notification method may be implemented in combination with or without the notifications shown in FIGS. 4-6.

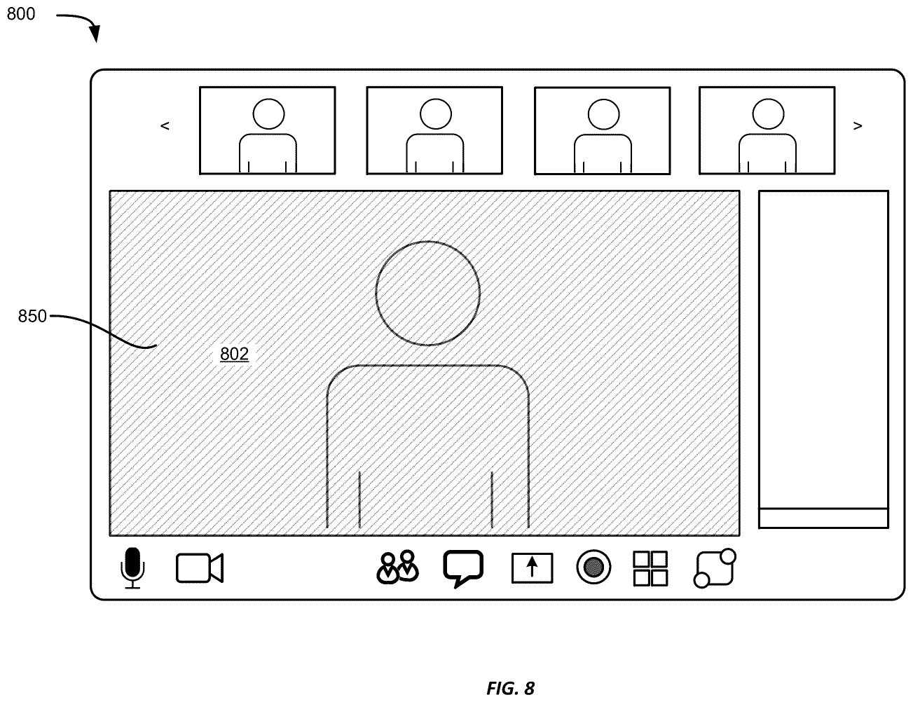

Referring to FIG. 8, FIG. 8 illustrates GUI 800 that includes a color notification 850. The color notification 850 may include overlaying a color mask over some or all of the GUI 800. For example, the color notification 850 may be limited to overlaying the virtual conference window or be overlayed over a participant defined area. In some aspects, the color notification 850 may blink or pulse. The frequency of blinking or pulsing may be participant defined or determined by the AI-assistant. The color notification 850 may fade in and out. In other examples, the color notification 850 may be configured by the participant to account for types of color blindness such as deuteranopia, protanopia, or similar. The brightness of the color notification 850 may be determined by the AI-assistant or the participant.

In some examples, the color notification 850 may include display distortions (e.g., blurring, focal shifts, or similar). The participant or AI-assistant may provide information relating to visual disabilities. The client application 303 may select a setting which alters the color notification 850 to account for the visual disabilities. For example, the AI-assistant could provide the color notification 850 in a center of the display for a participant with glaucoma or provide the color notification 850 near an edge of the display for a participant with age-related macular degeneration.

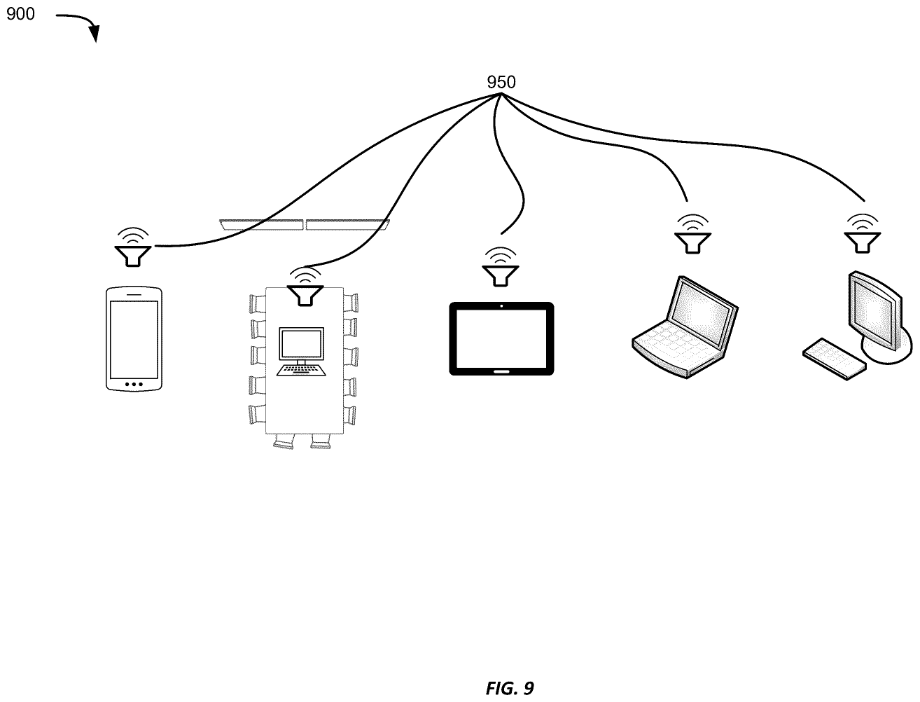

Referring to FIG. 9, FIG. 9 illustrates an audio notification 950 that may be provided by any number of client devices 301. The audio notifications 950 may be included independently or in combination with notifications described in any examples described in this disclosure. The audio notifications 950 may be a chime, beep, or any audio notification that can get the participants attention. In some examples, the audio notifications 950 can include portions of the transcript 335. The AI-assistant may audibly speak (using text-to-speech “TTS” or similar) the portions of the transcript 335 to the participant. In other examples, the AI-assistant may audibly recite the transcript 335 when the client device 301 receives the transcript 335 from the server(s) 330. When the word or phrase 412 is identified by the client device 301, the audio notification 950 may change tone, cadence, or volume to emphasize to the participant that a topic the participant is interested in had been mentioned or that the participant had been mentioned.

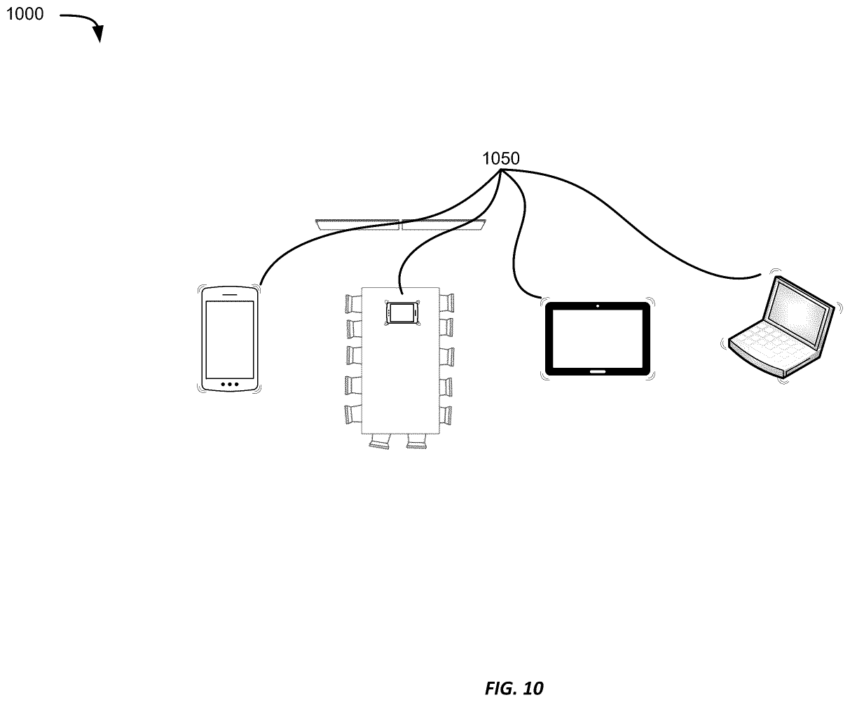

Referring to FIG. 10, FIG. 10 illustrates various haptic and tactile feedback notifications 1050 according to some examples of the present invention. The haptic and tactile feedback notifications 1050 described herein will be discussed with respect to the example system and example GUI above with respect to FIGS. 3 and 4. The haptic and tactile feedback notifications may include vibrations (e.g., smartphone vibrations or gyroscope oscillations) or deformations (e.g., micro-deformations on a display) perceivable to the participant. The haptic and tactile feedback notifications 1050 may persist for a predetermined time period or oscillate between active and inactive periodically. The participant may adjust the predetermined time period or frequency of oscillations using the client application 303. In other examples, the AI-assistant may determine appropriate settings for the haptic and tactile feedback notifications 1050.

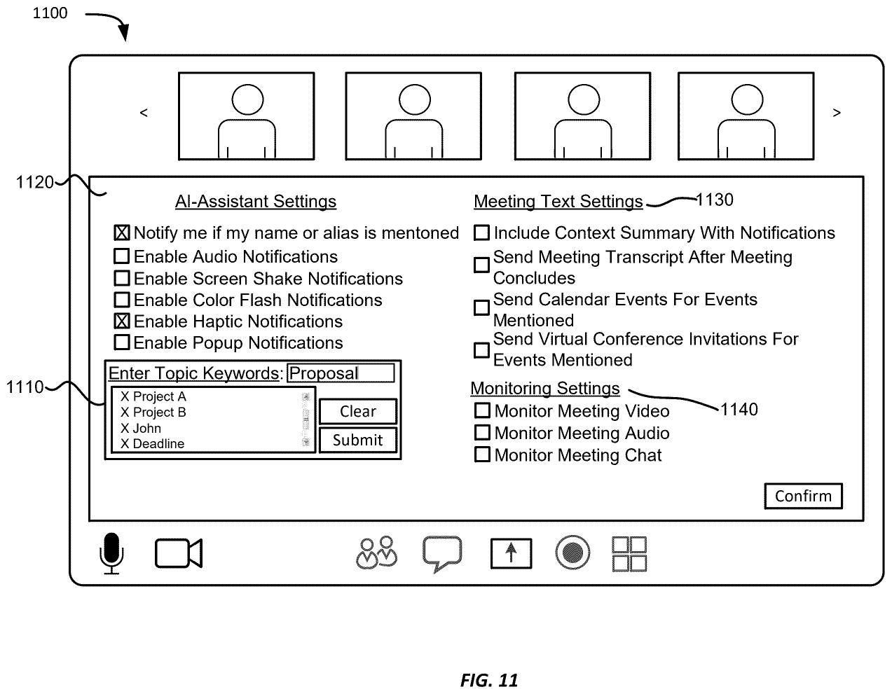

Referring to FIG. 11, FIG. 11 illustrates an example GUI 1100 which includes AI-assistant settings 1120. GUI 1100 described herein will be discussed with respect to the example system and example GUI above with respect to FIGS. 3 and 4. The AI-assistant settings 1120 enable a participant to input, change, update, or otherwise adjust parameters 416 that the AI-assistant uses to associate a word or phrase 412 with the participant. The participant can adjust the AI-assistant settings such as enabling various types of notifications described in other examples herein. In addition, the participant can create unique parameters 1110 that the AI-assistant can look for within the transcript 335. The unique parameters 1110 can be a single word or a group of words. In some examples, the unique parameters 1110 may be number(s) or symbol(s). The AI-assistant can generate a list of unique parameters based on topics that are to be discussed in the virtual conference or topics that are currently being discussed in the virtual conference.

In some examples, the participant may define meeting text settings 1130. The meeting text settings 1130 may relate to, but should not be limited to, additional settings the participant may define such as receiving a meeting transcript after the meeting ends or if a follow-up meeting is mentioned during the virtual conference, to have the AI-assistant schedule a calendar event for the participant. Additionally, the participant may define monitoring settings 1140 of the virtual conference. For example, the participant may define if the AI-assistant may monitor the video stream, the audio stream, or the chat window during the virtual conference.

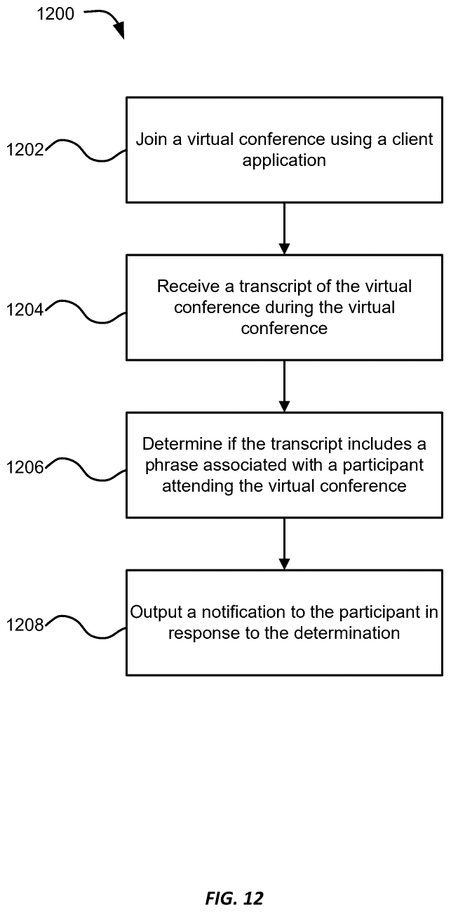

Referring now to FIG. 12, FIG. 12 shows an example method 1200 for using an artificial intelligence assistant “AI-assistant” to generate notifications during virtual conferences. The example method 1200 described herein will be discussed with respect to the example system and example GUI above with respect to FIGS. 3 and 4; however, it should be appreciated that any suitable systems or GUIs according to this disclosure may be employed.

At block 1202, the client device 301 joins a virtual conference. In this example, the client device 301 executes client application 303, which communicates with the virtual conference provider 310, generally as described above with respect to FIGS. 1-2. Subsequently, the client device 301 joins the virtual conference using the client application 303 that provides GUI 400 to interface with other participants also attending the virtual conference.

At block 1204, the client device 301 receives, substantially in real-time, a transcript 335 associated with audio and visual streams during the virtual conference. The audio and visual streams may be interactions (e.g., voice, text, gestures, camera video) provided by participants during the virtual conference. In this example, the AI-assistant may have access to the transcript 335 to monitor the virtual conference.

At block 1206, the client device 301 determines if the transcript 335 includes a word or phrase 412 associated with the participant attending the virtual conference. The word or phrase 412 can include a subset of words that may include a parameter 416 (e.g., a name, alias, or similar) associated with the participant. Alternatively, the phrase 412 can include one or more topics the participant is interested in.

At block 1208, the client device 301 outputs a notification 450 to the participant in response to determining that the word or phrase 412 is associated with the participant. The notification 450 may include a message, alert, a pop-up, an audible sound, or similar. While the notification 450 is described with respect to the GUI 400 of FIG. 4A, it should be appreciated that any suitable notifications or GUI according to this disclosure may be employed.

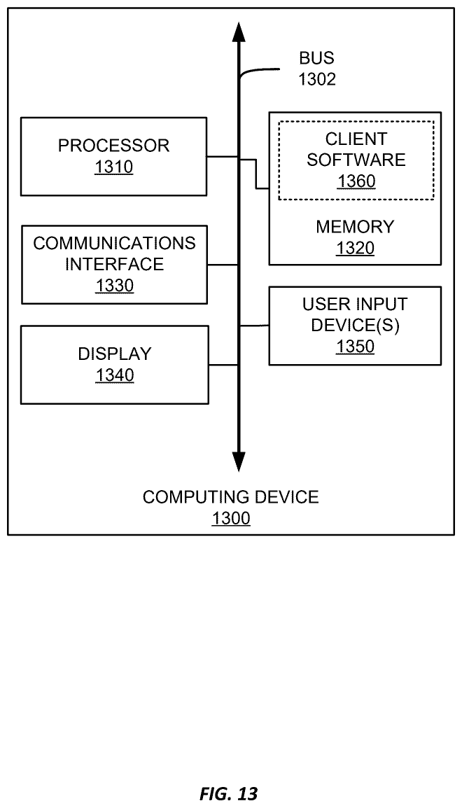

Referring now to FIG. 13, FIG. 13 shows an example computing device 1300 suitable for use in example systems or methods for using an AI-assistant to generate notifications during virtual conferences according to this disclosure. The example computing device 1300 includes a processor 1310 which is in communication with the memory 1320 and other components of the computing device 1300 using one or more communications buses 1302. The processor 1310 is configured to execute processor-executable instructions stored in the memory 1320 to perform one or more methods for using an AI-assistant to generate notifications during virtual conferences according to different examples, such as part or all of the example method 1200 described above with respect to FIG. 12. Suitable example computing devices 1300, such as user client devices, may also include one or more user input devices 1350, such as a keyboard, mouse, touchscreen, microphone, etc., to accept user input. The computing device 1300 also includes a display 1340 to provide visual output to a user. In addition, the computing device 1300 includes client software 1360, such as discussed above with respect to FIGS. 3-11.

The computing device 1300 also includes a communications interface 1330. In some examples, the communications interface 1330 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
joining, by a client device, a virtual conference using a client application executed by the client device, the virtual conference being attended by a participant, the client application providing a graphical user interface (GUI);
receiving, by the client device during the virtual conference, a transcript of the virtual conference from a server;
determining, by the client device, if the transcript includes a phrase associated with the participant; and
in response to determining that the transcript includes the phrase associated with the participant, outputting, by the client device, a notification to the participant on the GUI.

2. The method of claim 1, wherein outputting, by the client device, the notification to the participant on the GUI further comprises:
outputting, by the client device, a message to the participant, the message notifying the participant that the participant was mentioned in the virtual conference;
determining, by the client device, if the participant has performed an interaction with the client application within a time threshold; and
in response to determining if the participant has not performed the interaction within the time threshold, outputting, by the client device, a second message.

3. The method of claim 2, wherein the message includes highlighted text associated with the participant; and
wherein the second message includes the highlighted text and an audio response, a visual response, a tactile response, a haptic response, or a combination thereof.

4. The method of claim 1, further comprising:
selecting, by the client device, a subset of words of the transcript that includes the phrase, the subset of words providing context to the phrase;
modifying, by the client device, the subset of words to be highlighted, boldened, italicized, underlined, changed font size, changed font, or combinations thereof; and
outputting, by the client device, the subset of words of the transcript that includes the phrase on the GUI to the participant.

5. The method of claim 1, further comprising:
identifying, by the client device, a state of the participant;
determining, by the client device, if the state of the participant meets an engagement threshold, the state representing an active state or an inactive state of the participant; and
in response to determining if the state of the participant meets the engagement threshold, outputting, by the client device, an alert, wherein the alert includes an audio response, a visual response, a tactile response, a haptic response, or a combination thereof.

6. The method of claim 1, wherein joining the virtual conference using the client application executed by the client device further comprises:
receiving, by the client device, an input setting from the participant using the GUI of the client application;
generating, by the client device, a parameter based on the input setting; and
wherein determining if the transcript includes the phrase associated with the participant further comprises:
determining, by the client device, if the parameter is associated with the phrase.

7. The method of claim 1, wherein the notification includes an audio response, a visual response, a tactile response, a haptic response, or a combination thereof.

8. A client device comprising:
a processor; and
a memory that includes instructions executable by the processor for causing the processor to:
join a virtual conference using a client application, the virtual conference being attended by a participant, the client application providing a graphical user interface (GUI);
receive, during the virtual conference, a transcript of the virtual conference from a server;
determine if the transcript includes a phrase associated with the participant; and
in response to determining that the transcript includes the phrase associated with the participant, output a notification to the participant on the GUI.

9. The client device of claim 8, further comprising:
select a subset of words of the transcript that includes the phrase, the subset of words providing context to the phrase;
modify the subset of words to be highlighted, boldened, italicized, underlined, changed font size, changed font, or combinations thereof; and
output the subset of words of the transcript that includes the phrase on the GUI to the participant.

10. The client device of claim 8, wherein outputting the notification to the participant on the GUI further comprises:
output a message to the participant, the message notifying the participant that the participant was mentioned in the virtual conference;
determine if the participant has performed an interaction with the client application within a time threshold; and
in response to determining if the participant has not performed the interaction within the time threshold, output a second message.

11. The client device of claim 10, wherein the message includes highlighted text associated with the participant; and
wherein the second message includes the highlighted text and an audio response, a visual response, a tactile response, a haptic response, or a combination thereof.

12. The client device of claim 8, further comprising:
identify a state of the participant;
determine if the state of the participant meets an engagement threshold, the state representing an active state or an inactive state of the participant; and
in response to determining if the state of the participant meets the engagement threshold, output an alert, wherein the alert includes an audio response, a visual response, a tactile response, a haptic response, or a combination thereof.

13. The client device of claim 8, wherein joining the virtual conference using the client application executed by the client device further comprises:
receive an input setting from the participant using the GUI of the client application;
generate a parameter based on the input setting; and
wherein determining if the transcript includes the phrase associated with the participant further comprises:
determine if the parameter is associated with the phrase.

14. The client device of claim 8, wherein the notification includes an audio response, a visual response, a tactile response, a haptic response, or a combination thereof.

15. A non-transitory computer-readable medium comprising instructions that are executable by a processor causing the processor to perform operations comprising:
joining a virtual conference using a client application, the virtual conference being attended by a participant, the client application providing a graphical user interface (GUI);
receiving a transcript of the virtual conference from a server;
determining if the transcript includes a phrase associated with the participant; and
in response to determining that the transcript includes the phrase associated with the participant, outputting a notification to the participant on the GUI.

16. The non-transitory computer-readable medium of claim 15, further comprising:
selecting a subset of words of the transcript that includes the phrase, the subset of words providing context to the phrase;
modifying the subset of words to be highlighted, boldened, italicized, underlined, changed font size, changed font, or combinations thereof; and
outputting the subset of words of the transcript that includes the phrase on the GUI to the participant.

17. The non-transitory computer-readable medium of claim 15, wherein outputting the notification to the participant on the GUI further comprises:
outputting a message to the participant, the message notifying the participant that the participant was mentioned in the virtual conference;
determining if the participant has performed an interaction with the client application within a time threshold; and
in response to determining if the participant has performed the interaction within the time threshold, outputting a second message.

18. The non-transitory computer-readable medium of claim 17, wherein the message includes highlighted text associated with the participant; and
wherein the second message includes the highlighted text and an audio response, a visual response, a tactile response, a haptic response, or a combination thereof.

19. The non-transitory computer-readable medium of claim 15, further comprising:
identifying a state of the participant;
determining if the state of the participant meets an engagement threshold, the state representing an active state or an inactive state of the participant; and
in response to determining if the state of the participant meets the engagement threshold, outputting an alert, wherein the alert includes an audio response, a visual response, a tactile response, a haptic response, or a combination thereof.

20. The non-transitory computer-readable medium of claim 15, wherein joining the virtual conference using the client application further comprises:
receiving an input setting from the participant using the GUI of the client application;
generating a parameter based on the input setting; and
wherein determining if the transcript includes the phrase associated with the participant further comprises:
determining if the parameter is associated with the phrase.
